(19) United States
(12) Patent Application Publication
(10) Pub. No.: US 2010/0200807 A1
(43) Pub. Date: Aug. 12, 2010

(54) Composition

(75) Inventors: Giorgio Franzolin, Mirano VE (IT); Luca Rosa Fauzza, Udine (IT); Danilo Bortolato, Mira (IT); Remigio Musci, Mira (IT); Antonio Cordellina, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V.

(21) Appl. No.: 12/601,683

(22) PCT Filed: May 30, 2008
(86) PCT No.: PCT/GB08/01866

§ 371 Date: Apr. 6, 2010

(30) Foreign Application Priority Data
Jun. 2, 2007 (GB) 0710559.6

(51) Int. Cl. C11D 3/22

(52) U.S. Cl. 252/186.1

(57) ABSTRACT

A process for the production of a bleach activator granule comprises the extrusion of a bleach activator composition. The composition comprises a bleach activator, a water swellable carbohydrate and water.

The present invention relates to granular bleach activators.

Detergents which contain per-compounds as bleaches are only effective in bleaching at high temperatures because the per-compounds do not decompose at sufficient speed at lower temperatures to be able to participate actively in the bleaching process. To counter this issue activators which react with the peroxo group of the per-compounds to form per-acids are employed. These per-acids are active at the low temperatures required for washing (delicate) fabrics.

These activators, which include N-acyl and O-acyl compounds, such as anhydrides or acid amides, as well as nitriles are very sensitive to hydrolysis, especially in the presence of the alkalis conventionally used in detergents.

This problem is accentuated by the fact that the activators are often only sparingly soluble in water, which is why they have to be employed in the form of a very fine powder to ensure more rapid dispersion. This fine form, however, by virtue of its greater surface area results in increased hydrolysis of the activators on storage.

This small powder (comprising the bleach activator in granular form, e.g. from 0.5 to 3 mm is usually made in an extrusion process. The extrusion process itself can give rise to a number of stability issues for the bleach activator granule.

The first disadvantage of the extrusion process is that an extrusion aid, e.g. a lubricating aid is required to be able to extrude the bleach activator composition.

Usually the extrusion aid comprises a lubricant such as a non-ionic surfactant. However, whilst these types of components are excellent lubrication aids (and also detergent actives) they can interact disadvantageously with the bleach activator making it more reactive once in contact with the persalt in the formulation giving poor stability and lower shelf life.

A further issue with the extrusion process is that typically the extruded granules have a high level of porosity. This leads to poor stability and lower shelf life since the granules permit a higher level of external moisture ingress, and an intimate contact with persalt and other ingredients typically present in a detergent formulation e.g, alkalies hence an undesirable level of hydrolysis of the bleach activator active.

It is an object of the present invention to obviate/mitigate the problems outlined above.

According to the present invention there is provided a process for the production of a bleach activator granule comprising the extrusion of a bleach activator composition, the composition comprising a bleach activator, a water swellable carbohydrate and water.

We have found that the process of the present invention produces bleach activator granules which have excellent properties. These properties are particularly the properties of high stability (particularly in long term storage) and good flowability.

Without wishing to be bound by theory it is proposed that the excellent storage properties are connected with the TAED particles being more effectively coated in the process of the present invention. Thus it is reasoned that the TAED granule are largely completely coated with a protective layer rather than partially coated as is often observed with TAED granule production techniques described in the prior art. It is further postulated that larger TAED particles are more effectively coated due to a combination of one or both of agglomeration associated coating and fragmentation into smaller particles in the extrusion process making the coating process more efficient.

Additionally it has been found that the particles have advantageous dissolution properties in solution. Without wishing to be bound by theory it is postulated that as result of more effective coating of the TAED particles a slightly slower dissolution time is observed. This can be beneficial in a washing liquor which contains number of actives, and particularly for an enzyme containing wash liquor. In such a case as the TAED particles disperse into solution as a lower rate the bleach activator [which of course is enhanced by the presence of the bleach activator] is not accelerate quite so quickly as would be the case with an ordinary TAED granules. This has the effect that the enzyme has a longer activity period before it is degraded by interaction with the bleach.

The granules in general have a size of from 0.1 to 10 mm, more preferably from 0.5 to 3 mm, preferably from 0.5 to 2 mm.

Preferably the bleach activator composition comprises about 10-98% of a bleach activator, more preferably 20-950, more preferably 30-90%, more preferably 50-90%, more preferably 70-90%, and most preferably about 88%.

Preferably the bleach activator used in the granule (i.e. before extrusion) is particulate. A suitable particle size for the bleach activator is in the range of 50-500 μm, more preferably from 100-300 μm.

Examples of bleaching activators for per-compounds are O-N-acylated compounds, such as pentaacetylglucose (PAG), pentapropionylglucose (PPG), tetraacetylethylenediamine (TAED), tetraacetylglycoluril (TAGU), carboxylic acid anhydrides, such as succinic anhydride, benzoic anhydride or phthalic anhydride, and salts of mixed anhydrides, such as sodium or magnesium diacetyl-phosphate (NADAP and MGDAP), as well as phenol esters, e.g. (p-carboxyphenyl acetate, p-sulfonylphenyl acetate, p-cresyl acetate and phenyl acetate.

Preferably the bleach activator comprises TAED.

It has been found that the inclusion of water as extrusion aid in the bleach activator composition is extremely advantageous. Without wishing to be bound by theory it is postulated that the inclusion of water has a number of separate advantages.

These include a positive influence on the temperature of the extrusion process. The presence of water is able to ensure that in the extrusion process the extrusion temperature is not elevated excessively which could otherwise lead to detrimental decomposition of the bleach activator. This positive influence is shown in the extrusion process per se and in any conditioning steps which can occur after the granules have been extruded. The water content of the bleach activator composition has been found to be extremely easy to remove after the extrusion and subsequent conditioning steps.

It has also been observed that the water is a highly beneficial extrusion aid.

Perhaps the most important advantage is that with the process of the present invention the bleach activator granules produced have been observed to have a low porosity. This is a great aid in the prevention of moisture uptake into the granule post production and further enhances the stability of the granule. The value of this advantage is not to be under-estimated. Currently in detergent formulations an excess of, for example, TAED, is added to the formulation working on the basis that a certain proportion of the TAED will decompose before the detergent is used. In the process of the present invention the enhanced stability of the granules produced means that a lower amount of bleach activator granules can be added to the detergent formulation (since the amount of decomposition is lower) thus saving costs.

Preferably the bleach activator composition comprises of water, more preferably from 1 to 30%, more preferably from 1 to 20%, and most preferably about 10%.

The bleach activator may be coated with a further coating.

Preferably the carbohydrate is cellulose or modified cellulose. Preferred examples of modified celluloses include cellulose ethers, cellulose esters, cellulose amides; such as methylcellulose, carboxymethylcellulose sodium, ethylcellulose, hydroxyethyl cellulose, hydroxypropyl methylcellulose, cellulose acetate, cellulose acetate phthalate and hydroxypropyl methyl cellulose (HPMC),

Alternatives the carbohydrate may be a polysaccharide such as starch, modified starch (e.g. carboxy-methyl starch), dextrin, polymannan, polyglucan, polyglucomannan, polyxyloglucan and polygalactomannan, maltodextrin and/or gelatine.

The granule may contain another component of a detergent composition. Indeed in this regard it has been found that when one or more components of a detergent composition is included in the granule of the present invention this is advantageous in that the component is protected from the remainder of the detergent composition. This can be important when the component is, for example, pH sensitive as many household detergent compositions, e.g. laundry and automatic dishwashing compositions are highly alkaline.

One such component which is sensitive is an anti-foam agent, such as a polysiloxane. Polysiloxanes are pH sensitive and as such find greater stability and consequently longer shelf life when contained in a granule according to the present invention.

Other components which can be included in the granule pre-mix include anionic surfactants such as LAS and/or non-ionic surfactants such as fatty, acid/alcohol ethoxylates. Builders such as polycarboxylates can be included in the granule.

According to a second aspect of the present invention there is provided a bleach activator granule made in a process comprising the extrusion of a bleach activator composition, the composition comprising a bleach activator, a water swellable carbohydrate and water.

The bleach activator granule is preferably for use in a detergent composition. The detergent composition is preferably granular (including compressed granular formats) and includes other detergent components.

1. A process for the production of a bleach activator granule comprising the process step of: extruding bleach activator composition comprising a bleach activator, a water swellable carbohydrate and water.

2. A process according to claim 1, wherein the granules have a size of from 0.1 to 10 mm.

3. A process according to claim 1, wherein the bleach activator composition comprises about 10-98% of a bleach activator.

4. A process according to claim 1, wherein the bleach activator comprises TAED.

5. A process according to claim 1 wherein the bleach activator composition comprises from 1 to 30% of water.

6. A process according to claim 1, wherein the bleach activator is coated.

7. A bleach activator granule formed by a process according to claim 1.

8. A detergent composition comprising a bleach activator granule according to claim 7.

9. A process according to claim 2, wherein the granules have a size of from 0.5 to 3 mm.

10. A process according to claim 9, wherein the granules have a size of from 0.5 to 2 mm.

11. A process according to claim 3, wherein the bleach activator composition comprises about 20-95% of a bleach activator.

12. A process according to claim 11, wherein the bleach activator composition comprises about 30-90% of a bleach activator.

13. A process according to claim 12, wherein the bleach activator composition comprises about 50-90% of a bleach activator.

14. A process according to claim 13, wherein the bleach activator composition comprises about 70-90% of a bleach activator.

15. A process according to claim 14, wherein the bleach activator composition comprises about 88% of a bleach activator.

16. A process according to claim 5, wherein the bleach activator composition comprises from 1 to 20% of water.

17. A process according to claim 16, wherein the bleach activator composition comprises about 10% of water.
